(19) United States
(12) Patent Application Publication
(10) Pub. No.: US 2026/0016122 A1
(43) Pub. Date: Jan. 15, 2026

(54) GIMBAL APPARATUS, ITS CONTROL METHOD, AND STORAGE MEDIUM

(71) Applicant: CANON KABUSHIKI KAISHA, Tokyo (JP)

(72) Inventor: HIROKI KITANOSAKO, Tokyo (JP)

(21) Appl. No.: 19/229,354

(22) Filed: Jun. 5, 2025

(30) Foreign Application Priority Data
Jul. 11, 2024 (JP) 2024-111447

(51) Int. Cl. F16M 13/04; F16M 11/04; F16M 11/20; F16M 11/24

(52) U.S. Cl. CPC F16M 13/04; F16M 11/048; F16M 11/2035; F16M 11/2085; F16M 11/2092; F16M 11/24

(57) ABSTRACT

A gimbal apparatus to which a mounted object is detachably attachable includes a slider translatable in a predetermined direction, a rotator rotatable around a predetermined axis, a slide position detector configured to detect position information on the slider, a rotation position detector configured to detect rotation angle information on the rotator, a memory storing instructions, a processor that, upon execution of the instructions, is configured to control the slider based on the position information and control the rotator based on the rotation angle information, a fixed unit configured to fix the mounted object, and a tilt detector configured to detect a tilt angle of the mounted object fixed to the fixed unit relative to a predetermined position. The processor is configured to determine a moving amount of the slider so as to reduce the tilt angle.

### BACKGROUND

### Field of the Technology

The present disclosure relates to a gimbal apparatus, its control method, and a storage medium.

### Description of the Related Art

To use the gimbal apparatus properly, it is important to adjust the balance (center of gravity) of the gimbal apparatus including a mounted object. Japanese Patent Application Laid-Open No. 2017-211626 discloses a method of adjusting the center of gravity by moving the weight of the gimbal apparatus according to a change in the center of gravity in the optical axis direction caused by the lens zooming in a camera as a mounted object. Japanese Patent Application Laid-Open No. 2018-56636 discloses a method in a lens interchangeable type camera in which the camera acquires lens center-of-gravity information tagged to an ID from the attached lens and calculates the center-of-gravity position of a combination of the camera and the lens.

In a case where information about the mounted object, such as center-of-gravity information, cannot be acquired, it is difficult for the methods disclosed in Japanese Patent Application Laid-Open Nos. 2017-211626 and 2018-56636 to reduce the time for balance adjustment.

### SUMMARY

A gimbal apparatus according to one aspect of the present disclosure to which a mounted object is detachably attachable includes a slider translatable in a predetermined direction, a rotator rotatable around a predetermined axis, a slide position detector configured to detect position information on the slider, a rotation position detector configured to detect rotation angle information on the rotator, a memory storing instructions, a processor that, upon execution of the instructions, is configured to control the slider based on the position information and control the rotator based on the rotation angle information, a fixed unit configured to fix the mounted object, and a tilt detector configured to detect a tilt angle of the mounted object fixed to the fixed unit relative to a predetermined position. The processor is configured to determine a moving amount of the slider so as to reduce the tilt angle. A control method of the above gimbal apparatus also constitutes another aspect of the present disclosure. A storage medium storing a program that causes a computer to execute the above control method also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is an external view of a gimbal apparatus according to this embodiment.

FIG. 2 is a block diagram of an imaging system according to this embodiment.

FIGS. 3A and 3B are flowcharts illustrating a method for controlling the gimbal apparatus according to this embodiment.

FIGS. 4A, 4B, and 4C explain balance adjustment of a fourth slide plate according to this embodiment.

FIG. 5 explains target moving amounts of third and fourth slide plates according to this embodiment.

FIGS. 6A, 6B, and 6C explain balance adjustment of a second slide plate according to this embodiment.

FIG. 7 explains target moving amounts of the second and third slide plates according to this embodiment.

FIGS. 8A, 8B, and 8C explain a target moving amount of the third slide plate according to this embodiment.

FIGS. 9A and 9B explain a target moving amount of a first slide plate according to this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

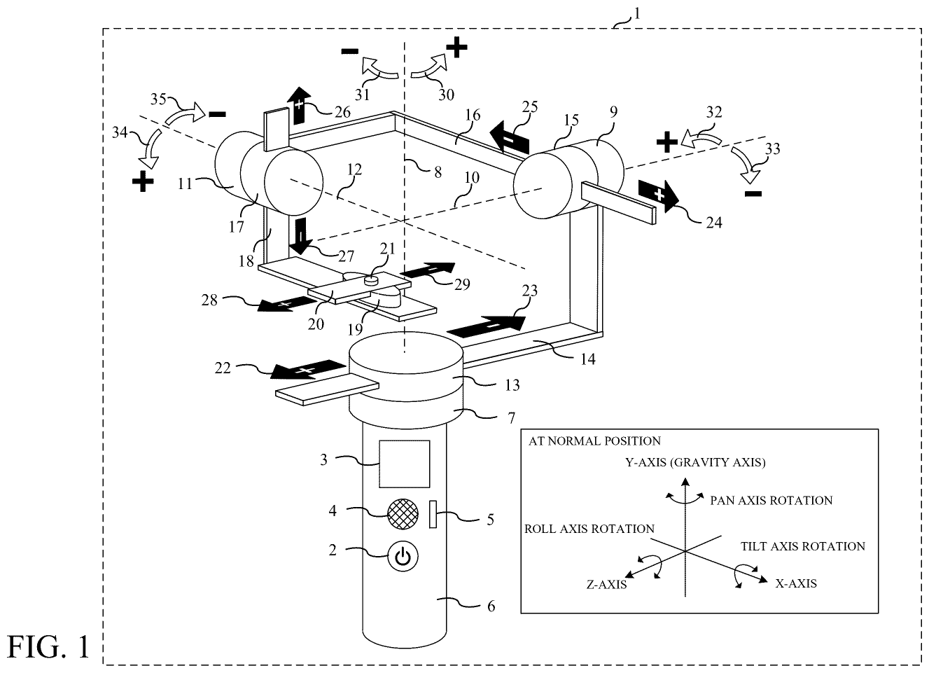

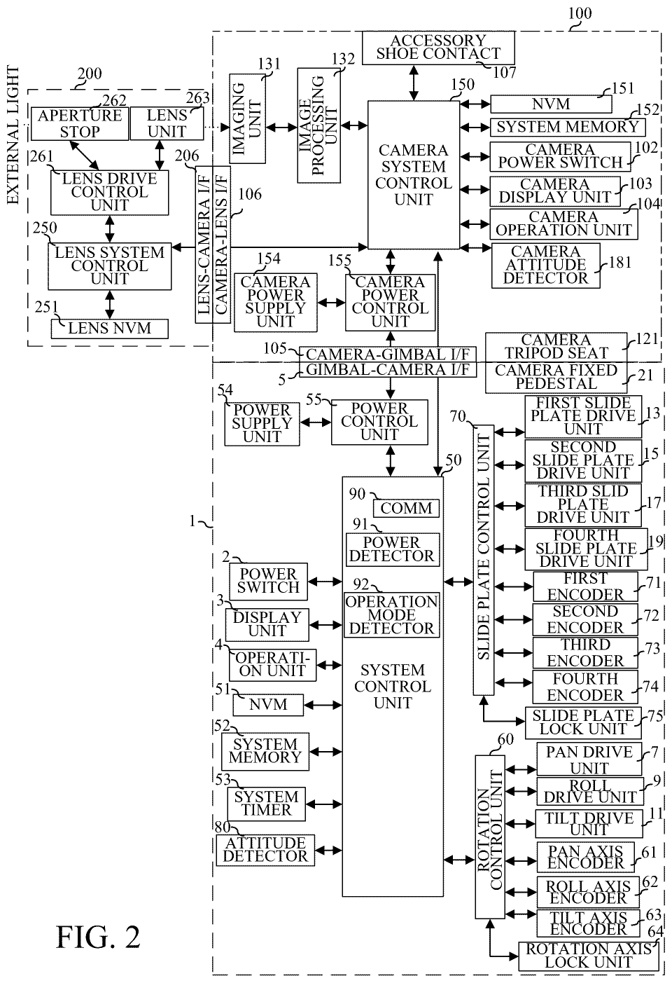

Referring now to FIG. 1, a description will be given of a gimbal apparatus 1 as an example of an electronic apparatus according to this embodiment. FIG. 1 is an external view of the gimbal apparatus 1. In FIG. 1, a power switch 2 is an operation member for switching between powering-on and powering-off of the gimbal apparatus 1. A display unit 3 is a display unit provided on the gimbal apparatus 1 for displaying various information. An operation unit 4 is an operation member for issuing various instructions to the gimbal apparatus 1 or the image pickup apparatus 100 described with reference to FIG. 2. The operation unit 4 is, for example, an operation member combining a push button and an eight-way key, but is not limited to this example. The number of operation members is also not limited to this example.

A gimbal camera interface (I/F) 5 is an interface for connecting the gimbal apparatus 1 and the image pickup apparatus 100. The gimbal camera I/F 5 is, for example, a connector for connecting to the image pickup apparatus 100 via a USB cable (not illustrated), but the gimbal camera I/F 5, including its arrangement is not limited to this example. A grip portion 6 is a holder shaped to be easily gripped by the user who holds the gimbal apparatus 1.

A pan drive unit 7 includes a first rotational drive motor and is a rotator (first rotator rotatable around ae first rotation axis) configured to rotate a mounted object of the gimbal apparatus 1 around a first rotation axis (pan rotation axis 8, specified axis) (pan-axis rotation). The pan rotation axis 8 is an axis parallel to the longitudinal direction of the grip portion 6 and is the rotation center of the pan drive unit 7.

A roll drive unit 9 includes a second rotational drive motor and is a rotator (second rotator rotatable around a second rotation axis) configured to rotate the mounted object of the gimbal apparatus 1 around the second rotation axis (roll rotation axis 10, specified axis) (roll-axis rotation). The roll rotation axis 10 is an axis that is disposed on a plane including the pan rotation axis 8 and is a rotation center of the roll drive unit 9.

A tilt drive unit 11 includes a third rotational drive motor and is a rotator (a third rotator rotatable around a third rotation axis) configured to rotate the mounted object of the gimbal apparatus 1 around a third rotation axis (tilt rotation axis 12, a specified axis) (tilt-axis rotation). The tilt rotation axis 12 is an axis orthogonal to the roll rotation axis 10 and is the rotation center of the tilt drive unit 11. In this embodiment, each rotational drive motor is a three-phase brushless DC motor configured to rotate the mounted object of the gimbal apparatus 1 around each rotation axis, but is not limited to this example.

A first slide plate drive unit 13 includes a first slide drive motor and can move a first slide plate (first slider) 14 along a first slide axis (first direction, predetermined direction) orthogonal to the pan rotation axis 8. The first slide plate 14 is a mechanism (slider) that is driven by the first slide plate drive unit 13 and translatable to an arbitrary position in the first direction.

A second slide plate drive unit 15 includes a second slide drive motor and can move a second slide plate (second slider) 16 along a second slide axis (second direction, predetermined direction) orthogonal to the roll rotation axis 10. The second slide plate 16 is a mechanism (slider) that is driven by the second slide plate drive unit 15 and translatable to an arbitrary position in the second direction.

A third slide plate drive unit 17 includes a third slide drive motor and can move a third slide plate (third slider) 18 along a third slide axis (third direction, predetermined direction) orthogonal to the tilt rotation axis 12. The third slide plate 18 is a mechanism (slider) that is driven by the third slide plate drive unit 17 and translatable to an arbitrary position in the third direction.

A fourth slide plate drive unit 19 includes a fourth slide drive motor and can move the fourth slide plate (fourth slider) 20 along a fourth slide axis (fourth direction, predetermined direction). The fourth slide plate 20 is a mechanism (slider) that is driven by the fourth slide plate drive unit 19 and translatable to an arbitrary position in the fourth direction. In this embodiment, each slide drive motor is a linear actuator that linearly moves the mounted object of the gimbal apparatus 1 according to a control signal, but is not limited to this example.

A camera fixed pedestal 21 is a pedestal (fixed unit configured to fix the mounted object) to which the mounted object of the gimbal apparatus 1 is attached. The mounted object of the gimbal apparatus 1 is, for example, the image pickup apparatus 100, and is attached by a tripod screw, but is not limited to this example.

Next, the first to fourth slide axes will be described. Here, the three axes that form a three-dimensional orthogonal coordinate system will be called an X-axis, a Y-axis, and a Z-axis, and the axis parallel to the gravity axis will be defined as the Y-axis. This description assumes that the gimbal apparatus 1 is placed at a normal position (predetermined position). Here, the normal position refers to a state in which the long side of the grip portion 6 is parallel to the gravity axis (Y-axis), the camera fixed pedestal 21 is orthogonal to the Y-axis, and the optical axis of the image pickup apparatus 100 attached to the camera fixed pedestal 21 is orthogonal to the Y-axis. The axis parallel to the optical axis of the image pickup apparatus 100 will be defined as the Z-axis, and the X-axis is defined as an axis orthogonal to the YZ plane.

In a case where the gimbal apparatus 1 is oriented at the normal position, the first slide axis and the fourth slide axis are parallel to the Z-axis, and the +direction of the Z-axis is defined as a first slide axis +direction 22 and a fourth slide axis +direction 28, respectively. The −direction of the Z-axis is defined as a first slide axis −direction 23 and a fourth slide axis −direction 29, respectively. The second slide axis is parallel to the X-axis, and the +direction of the X-axis is defined as a second slide axis +direction 24, and the −direction of the X-axis is defined as a second slide axis −direction 25, respectively. The third slide axis is parallel to the Y-axis, and the +direction of the Y-axis is defined as a third slide axis +direction 26, and the −direction of the Y-axis is defined as a third slide axis −direction 27.

A rotation direction will be defined as follows: In a case where the gimbal apparatus 1 is oriented at the normal position, a clockwise rotation direction with respect to the +direction of the Y-axis will be defined as a pan axis rotation +direction 30, and a counterclockwise rotation direction will be defined as a pan axis rotation −direction 31. Similarly, a clockwise rotation direction with respect to the +direction of the Z-axis will be defined as a roll axis rotation +direction 32, and a counterclockwise rotation direction with respect to the −direction of the X-axis will be defined as a tilt axis rotation +direction 34, and a counterclockwise rotation direction with respect to a −direction of the X-axis will be defined as a tilt axis rotation −direction 35. However, the definitions and relationships of these axes are merely examples, and are not limited to this example.

Next follows a description of the control of the gimbal apparatus 1 for holding the optical axis of the image pickup apparatus 100 in an arbitrary direction (for example, the Z-axis direction). The gimbal apparatus 1 includes the above first to third rotational drive motors included in the pan drive unit 7, roll drive unit 9, and tilt drive unit 11, as well as each of axis encoders 61, 62, and 63, which will be described later with reference to FIG. 2. A system control unit 50 can calculate an angle (target value) of each rotational drive unit required to hold the optical axis of the image pickup apparatus 100 in an arbitrary direction. The system control unit 50 supplies power to each rotational drive unit via the rotation control unit 60 so as to reduce (or eliminate) a difference between the value (current value) of the rotation position detector (each of the axis encoders 61, 62, and 63) and a target value. It is assumed that the power supplied to each rotational drive unit is determined by PID control for the control deviation (a difference between the target value and the current value), but this embodiment is not limited to this example.

Next follows a description of balance adjustment. As a premise, that the gimbal apparatus 1 is in a balanced state (balance-adjusted) is that the center of gravity of a mounted object (loaded item) is located on the pan rotation axis 8, the roll rotation axis 10, and the tilt rotation axis 12. Here, the mounted object is used to mean a mounted object for the pan drive unit 7, the roll drive unit 9, and the tilt drive unit 11. That is, the mounted object for the tilt drive unit 11 includes the third slide plate drive unit 17, the third slide plate 18, the fourth slide plate drive unit 19, the fourth slide plate 20, and the camera fixed pedestal 21 in addition to the image pickup apparatus 100 and the lens apparatus 200. The mounted object for the roll drive unit 9 includes the second slide plate 16 and the second slide plate drive unit 15 in addition to the mounted object for the tilt drive unit 11. The mounted object for the pan drive unit 7 includes the first slide plate 14 and the first slide plate drive unit 13 in addition to the mounted object for the roll drive unit 9.

In a case where the gimbal apparatus 1 is in balance, no rotational force is applied to the image pickup apparatus 100 unless power is supplied to the pan drive unit 7, the roll drive unit 9, and the tilt drive unit 11. On the other hand, in a case where the gimbal apparatus 1 is out of balance, a rotational force is applied that moves the center of gravity in the gravity direction, so that in order to maintain the optical axis of the image pickup apparatus 100 in an arbitrary direction, it is necessary to keep supplying power to the pan drive unit 7, roll drive unit 9, and tilt drive unit 11. At this time, the power supplied to the pan drive unit 7, the roll drive unit 9, and the tilt drive unit 11 depends on the mass of each mounted object and a distance from the rotation center to the center of gravity of the mounted object.

As described above, the first to fourth slide plate drive units 13, 15, 17, and 19 can translate the first to fourth slide plates 14, 16, 18, and 20 to arbitrary positions. Therefore, translating each slide plate can move (change) the center of gravity of the mounted object and maintain the optical axis of the image pickup apparatus 100 parallel to the Z-axis without supplying power to the pan drive unit 7, the roll drive unit 9, and the tilt drive unit 11. In this embodiment, moving the center of gravity of the mounted object to a proper position by translating each slide plate will be called balance adjustment.

Referring now to FIG. 2, a description will be given of the imaging system 1000 according to this embodiment will be described. FIG. 2 is a block diagram of the imaging system 1000. The imaging system 1000 includes the gimbal apparatus 1, the image pickup apparatus 100 connected to the gimbal apparatus 1, and the lens apparatus 200 connected to the image pickup apparatus 100.

The system control unit 50 is a control unit consisting of at least one processor or circuit, and controls the entire gimbal apparatus 1. The system control unit 50 executes the programs recorded in a nonvolatile memory 51 to realize various processing described later according to this embodiment. The system control unit 50 also loads the programs read from the nonvolatile memory 51 into a system memory 52 to realize various calculation processing. The system control unit 50 can also detect an operation mode (fixed angle-of-view mode, follow mode, etc.) and state (static state, hand-held, walking shooting, running shooting, panning, tilting, etc.) of the gimbal apparatus 1 as work process information.

The system control unit 50 includes a communication unit 90 inside, and can communicate with a camera system control unit 150 via the gimbal camera I/F 5 to communicate various information. The various information includes, for example, control instructions for the image pickup apparatus 100, an individual ID of the image pickup apparatus 100, and information on the operation mode (still image capturing mode, moving image capturing mode, live-view (LV) mode, MENU mode, SLEEP mode, etc.). The various information may include information on the attitude (orientation), motion, center-of-gravity coordinates, mass, motion vector of a captured image, remaining battery level, and an attached accessory of the image pickup apparatus 100. The various information may include information on the lens apparatus 200 obtained by the camera system control unit 150 (described later) communicating with a lens system control unit 250, and various calculation results calculated by the camera system control unit 150.

The nonvolatile memory 51 is an electrically erasable and recordable memory, such as a Flash-ROM. The nonvolatile memory 51 stores constants and programs for the operation of the system control unit 50. The programs here refer to programs for executing various flowcharts described later according to this embodiment. The nonvolatile memory 51 stores center of gravity and mass information on various members of the gimbal apparatus 1.

The system memory 52 is, for example, a RAM. The constants and variables for the operation of the system control unit 50 and the programs of the nonvolatile memory 51 are loaded in the system memory 52. A system timer 53 is a clock unit that measures the time for various controls and the time of a built-in clock. A power supply unit 54 includes primary batteries such as alkaline batteries and lithium batteries, secondary batteries such as NiCd batteries, NiMH batteries, and Li batteries, and an AC adapter.

A power control unit 55 includes a battery detection circuit, a DC-DC converter, a PD-IC (USB power delivery control IC), a switch circuit, and other components, and detects whether a battery is attached, the type of battery, and the remaining battery power. The power control unit 55 also controls the DC-DC converter based on the detection results and instructions from the system control unit 50, and supplies the necessary power for the necessary period to each block inside the gimbal apparatus 1. The power control unit 55 communicates with the camera power control unit 155 via the gimbal camera I/F 5, and can communicate various information and power. Here, the various information includes information on the individual ID, mass, center-of-gravity coordinates, remaining battery power, and other information on the image pickup apparatus 100 and the lens apparatus 200 connected to the image pickup apparatus 100.

A rotation control unit 60 includes a motor driver, an encoder detection circuit, etc., and can detect the rotation angle and rotation speed of each axis rotation drive motor from the output signals of each of the axis encoder 61, 62, and 63 described later. The rotation control unit 60 also supplies an arbitrary power amount to the pan drive unit 7, roll drive unit 9, and tilt drive unit 11 based on the rotation angle detection result and instructions from the system control unit 50, to rotate the rotation drive motor of each rotation axis. The rotation control unit 60 sends a control signal to a rotation axis lock unit 64 described later based on instructions from the system control unit 50, to fix (lock) each rotation axis (pan drive unit 7, roll drive unit 9, and tilt drive unit 11) so that it does not rotate.

The pan axis encoder 61 is located near the pan drive unit 7, and outputs absolute value information on the rotation angle of the pan drive unit 7 centered on the pan rotation axis 8, based on an arbitrary angle, to the rotation control unit 60 as an electrical signal. The roll axis encoder 62 is disposed near the roll drive unit 9, and outputs absolute value information on the rotation angle of the roll drive unit 9 around the roll rotation axis 10, based on an arbitrary angle, to the rotation control unit 60 as an electrical signal. The tilt axis encoder 63 is disposed near the tilt drive unit 11, and outputs absolute value information on the rotation angle of the tilt drive unit 11 around the tilt rotation axis 12, based on an arbitrary angle, to the rotation control unit 60 as an electrical signal. These encoders have magnetic sensors such as Hall elements, but are not limited to this.

The rotation axis lock unit 64 is a mechanical mechanism that physically locks the rotation of each axis at an arbitrary angle, and can select whether to fix (lock) or set free (release or unlock) the rotation control unit 60.

A slide plate control unit 70 includes a motor driver and an encoder detection circuit, etc., and detects the position, moving amount, and moving speed of each axis slide plate from the output signals of each of axis encoders (slide axis detectors) 71, 72, 73, and 74 described later. The slide plate control unit 70 supplies arbitrary power to the first to fourth slide plate drive units 13, 15, 17, 19 to move each axis slide plate based on a moving amount detection result and the instruction of the stem control unit 50. Also, based on the instruction of the system control unit 50, the slide plate control unit 70 outputs a control signal to a slide plate lock unit 75 described later to fix (lock) the position of each axis slide plate.

The first encoder 71 is located near the first slide plate drive unit 13, and outputs an electric signal corresponding to the position of the first slide plate 14 to the slide plate control unit 70. The second encoder 72 is located near the second slide plate drive unit 15, and outputs an electric signal corresponding to the position of the second slide plate 16 to the slide plate control unit 70. The third encoder 73 is disposed near the third slide plate drive unit 17 and outputs an electric signal corresponding to the position of the third slide plate 18 to the slide plate control unit 70. The fourth encoder 74 is disposed near the fourth slide plate drive unit 19 and outputs an electric signal corresponding to the position of the fourth slide plate 20 to the slide plate control unit 70. Each of these encoders has an optical sensor such as a photo-interrupter or a photo-reflector, or a magnetic sensor such as a Hall element, but is not limited to this example.

The slide plate lock unit 75 is a mechanical mechanism that physically fixes (locks) each axis slide plate at an arbitrary position, and can select whether to fix (lock) or set free (release or unlock) it under the control of the slide plate control unit 70.

An attitude detector (tilt detector) 80 includes a circuit including a gyro sensor and an acceleration sensor, and detects the attitude and motion of the grip portion 6 with respect to the gravity direction, and the camera fixed pedestal 21 to which the image pickup apparatus 100 is attached. The attitude detector 80 can detect the attitude of the camera fixed pedestal 21 by, for example, placing an acceleration sensor on the third slide plate 18, which maintains a constant positional relationship with the camera fixed pedestal 21 even with the tilt-axis rotation. Alternatively, the attitude detector 80 can detect the attitude of the camera fixed pedestal 21 by placing an acceleration sensor on the grip portion 6 and based on information from the acceleration sensor and information on the rotation angle of each axis rotation drive motor detected by the rotation control unit 60. The system control unit 50 sends instructions to the rotation control unit 60 and the slide plate control unit 70 so that the camera fixed pedestal 21 is in a desired attitude based on the information detected by the attitude detector 80.

The communication unit 90 is included in the system control unit 50 and enables communication with the image pickup apparatus 100 via an arbitrary interface. A power detector 91 is included in the system control unit 50 and enables the power supply unit 54 to detect the power and the direction of current supplied to the pan drive unit 7, the roll drive unit 9, and the tilt drive unit 11 via the rotation control unit 60. It enables the power supply unit 54 to detect the power and the direction of current supplied to the first to fourth slide plate drive units 13, 15, 17, 19 via the slide plate control unit 70. An operation mode detector 92 is included in the system control unit 50 and enables detection of the operation mode of the gimbal apparatus 1.

The gimbal apparatus 1 thus has been discussed. Next follows a description of the image pickup apparatus 100 and the lens apparatus 200 connected to the image pickup apparatus 100, as a mounted object on the gimbal apparatus 1.

The camera system control unit 150 is a control unit consisting of at least one processor or circuit, and controls the entire image pickup apparatus 100. The camera system control unit 150 executes programs stored in a nonvolatile memory 151 to realize various processing described later according to this embodiment. The camera system control unit 150 also loads the programs and the like read from the nonvolatile memory 151 into a system memory 152 to realize various calculation processing. The camera system control unit 150 also communicates with the system control unit 50 or the lens system control unit 250 via the camera gimbal I/F 105 or the camera lens I/F 106, and can communicate various information.

The nonvolatile memory 151 is an electrically erasable and recordable memory, and for example, a Flash-ROM or the like is used. Constants, programs, and the like for the operation of the camera system control unit 150 are recorded in the nonvolatile memory 151. The programs, as used herein, are programs for executing various flowcharts described later according to this embodiment. The system memory 152 is, for example, a RAM. In the system memory 152, constants and variables for the operation of the camera system control unit 150 and the program of the nonvolatile memory 151 are loaded.

A camera power supply unit 154 includes primary batteries such as alkaline batteries and lithium batteries, secondary batteries such as NiCd batteries, NiMH batteries, and Li batteries, and an AC adapter.

The camera power control unit 155 includes a battery detection circuit, a DC-DC converter, a PD-IC (USB power delivery control IC), a switch circuit, and other components, and detects whether a battery is attached, the type of battery, and the remaining battery level. The camera power control unit 155 controls the DC-DC converter based on the detection results and instructions from the camera system control unit 150, and supplies the necessary power for the necessary period to each block inside the gimbal apparatus. The camera power control unit 155 also communicates with the camera power control unit 155 via the camera gimbal I/F 105, and can communicate various information and power.

An imaging unit 131 includes an image sensor such as a CMOS or CCD. The camera executes imaging control based on instructions from the camera power control unit 155, processes captured image information acquired by the imaging unit 131 using the image processing unit 132, and transmits the result to the camera system control unit 150.

A camera operation unit 104 is an operation unit for inputting various predetermined operation instructions to the camera system control unit 150. The operation unit includes any one or combination of a switch, a dial, a touch panel, a voice recognition apparatus, and the like.

A camera display unit 103 is a display apparatus such as a rear monitor or electronic viewfinder, and includes liquid crystal such as an LCD or organic EL, etc., and displays a menu screen, a playback image, and a through image of data from the imaging unit 131. The camera display unit 103 may also function as a touch panel (operation unit). In this case, the touch panel constitutes part of the camera operation unit 104. A capacitance method is used as a touch detecting method, and the touch panel detects the proximity of a finger to the operation surface and a touch operation.

A camera attitude detector 181 includes a circuit including a gyro sensor or an acceleration sensor, and detects the attitude and motion of the image pickup apparatus 100 relative to the gravity direction. The camera system control unit 150 can determine in what attitude the image pickup apparatus 100 was taken in a case where an image was captured by the imaging unit 131 based on the information detected by the camera attitude detector 181. The camera system control unit 150 can also add the information detected by the camera attitude detector 181 to an image file of a captured image, or rotate and record the image.

An accessory shoe contact 107 includes a mechanism for connecting a peripheral camera accessory such as a strobe (not illustrated) or an external microphone (not illustrated), and a communication terminal for the camera system control unit 150 to communicate with a control unit (not illustrated) on the peripheral accessory side.

Next, the lens apparatus 200 will be described. The lens apparatus 200 is an interchangeable lens unit, and includes a lens unit 263, an aperture stop 262, a lens drive control unit 261 for driving the lens and the aperture stop for focusing control, a lens system control unit 250, and the like. External light from a composition including an object enters the imaging unit 131 of the image pickup apparatus 100 through the aperture stop 262 and the lens unit 263.

A lens camera I/F 206 is a lens connector, and includes a mechanism for attaching and detaching the lens apparatus 200, and a communication terminal for controlling focusing and the aperture stop. The lens system control unit 250 is a control unit including at least one processor or circuit, and controls the entire lens apparatus 200. The lens system control unit 250 achieves each processing described later according to this embodiment by executing a program recorded in a nonvolatile memory 251. The lens system control unit 250 communicates with the camera system control unit 150 via the lens camera I/F 206, and can communicate various information. The various information includes, for example, information on the individual ID, attitude, motion, center-of-gravity coordinates, and mass of the lens apparatus 200.

The nonvolatile memory 251 is an electrically erasable and recordable memory, such as a Flash-ROM. The nonvolatile memory 251 stores constants, programs, individual IDs, etc. for the operation of the lens system control unit 250. The programs, as used herein, refer to programs for executing various flowcharts described later according to this embodiment.

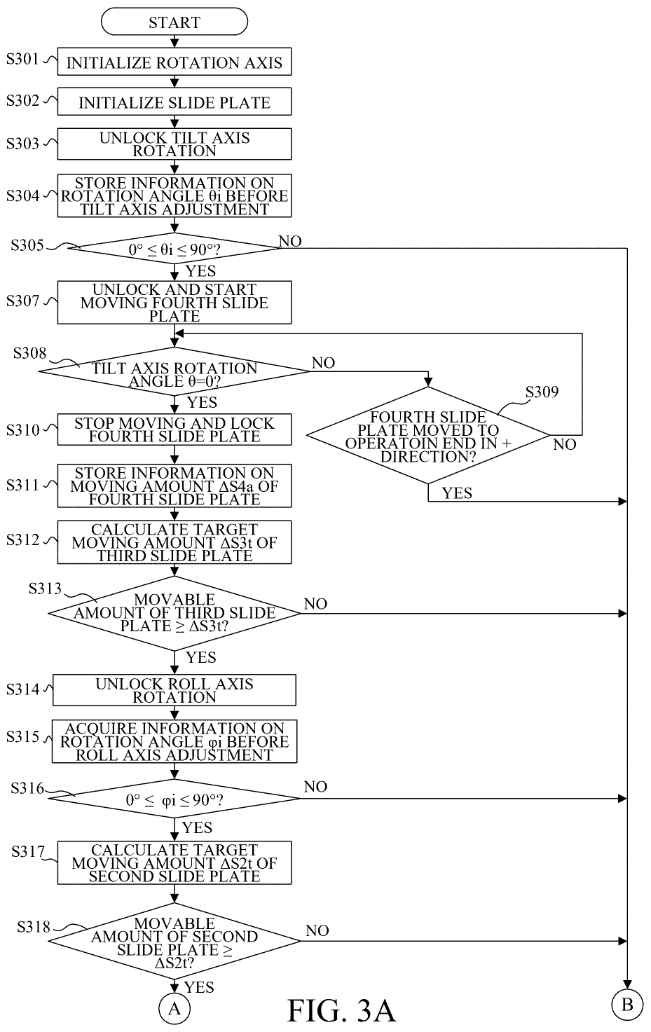

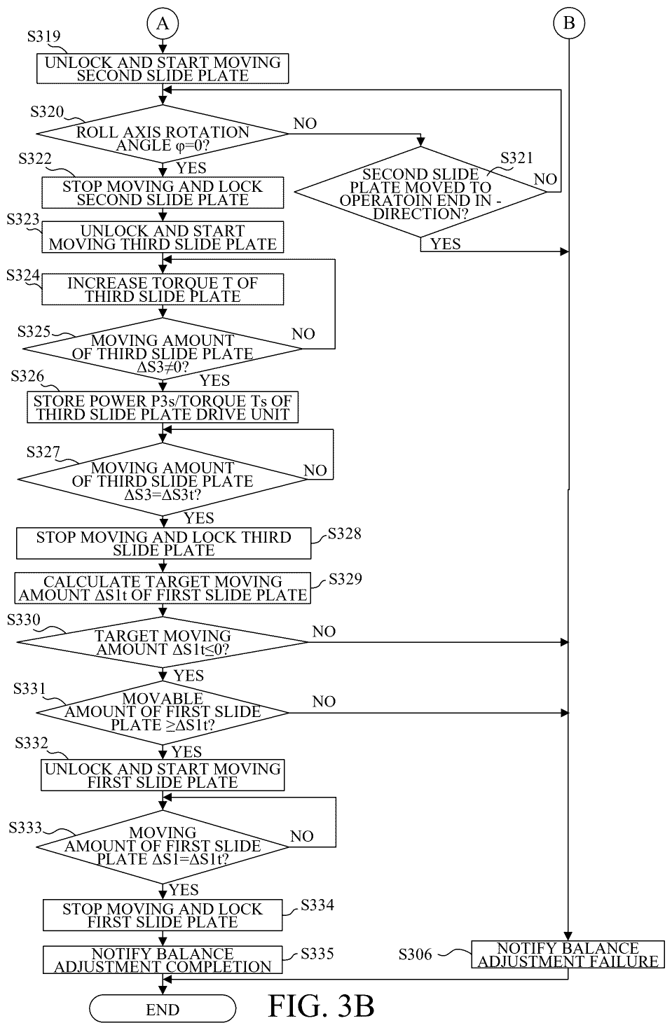

Referring now to FIGS. 3A to 9B, a description will be given of the center-of-gravity position control (balance adjustment) of the image pickup apparatus 100 and the lens apparatus 200 connected to the image pickup apparatus 100 mounted on the gimbal apparatus 1 according to this embodiment.

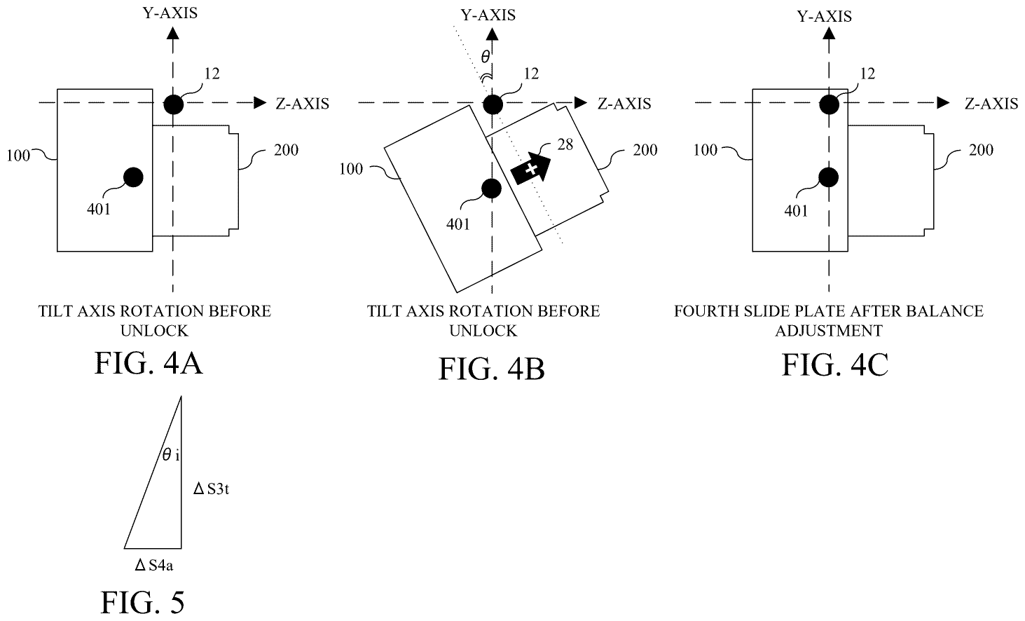

FIGS. 3A and 3B are flowcharts illustrating a method for controlling the gimbal apparatus 1 according to this embodiment. Each processing in the flowcharts in FIGS. 3A and 3B is achieved by the system control unit 50 in the gimbal apparatus 1 loading a program stored in the nonvolatile memory 51 into the system memory 52, executing it, and controlling each functional block. The overall flow will be described with reference to FIGS. 3A and 3B, and supplementary description regarding the movement of each slide plate will be provided with reference to FIGS. 4A to 9B.

In a case where the flowchart illustrated in FIGS. 3A and 3B starts, it is assumed that the image pickup apparatus 100 is attached to the camera fixed pedestal 21. The image pickup apparatus 100 may be attached to the camera fixed pedestal 21 before step S303 described later, and for example, there may be a flow in which the image pickup apparatus 100 is attached to the camera fixed pedestal 21 just after step S301 or step S302 described later.

First, in step S301, the system control unit 50 initializes the rotation axis. In the initialization of the rotation axis, the system control unit 50 controls the pan drive unit 7, the roll drive unit 9, and the tilt drive unit 11 so that the image pickup apparatus 100 mounted on the gimbal apparatus 1 is in the normal position (predetermined position), and fixes the rotation of each rotation axis with the rotation axis lock unit 64. At this time, since the balance adjustment is not completed, the pan drive unit 7, the roll drive unit 9, and the tilt drive unit 11 may not be able to output the torque required for rotational drive. Therefore, the user may be prompted to manually initialize the rotation axis.

Next, in step S302, the system control unit 50 moves each slide plate to its initial position. For example, the first slide plate 14 is moved to an operation end in the first slide axis +direction 22 by each slide plate drive unit, and the second slide plate 16 is moved to an operation end in the second slide axis +direction 24. The system control unit 50 also moves the third slide plate 18 to an operation end in the third slide axis −direction 27, and moves the fourth slide plate 20 to an operation end in the fourth slide axis −direction 29. The system control unit 50 then fixes each slide plate using the slide plate lock unit 75.

FIGS. 4A, 4B, and 4C are views of the image pickup apparatus 100 and the lens apparatus 200 viewed from the tilt drive unit 11 side, and explain the balance adjustment of the fourth slide plate 20. In step S302, the slide plate is moved to the initial position. Thus, as illustrated in FIG. 4A, a tilt-movable-unit center-of-gravity 401, which is the combination of the image pickup apparatus 100, the lens apparatus 200, the third slide plate drive unit 17 to the camera fixed pedestal 21, is assumed to be in the third quadrant on the YZ plane centered on the tilt rotation axis 12. At this time, in a case where the tilt axis rotation is unlocked by the rotation axis lock unit 64 in step S303, the tilt-movable-unit center-of-gravity 401 tilts so as to move onto the Y-axis (FIG. 4B).

Next, in step S304, the system control unit 50 defines the tilt angle of the tilt axis rotation of the image pickup apparatus 100 relative to the normal position as θ, and stores the tilt angle θi (rotation angle before tilt axis adjustment) obtained by the rotation control unit 60 just after the tilt axis rotation is unlocked. In this embodiment, the tilt angle θ (second tilt angle) of the image pickup apparatus 100 is a tilt angle relative to the normal position as the reference position (predetermined position) of the image pickup apparatus 100, but is not limited to this example, and a position other than the normal position may be the reference position.

Next, in step S305, the system control unit 50 determines whether the tilt angle θi is within a range of 0 to 90 degrees (0°≤θi ≤90°). In a case where the tilt-movable-unit center-of-gravity 401 is located in the third quadrant on the YZ plane centered on the tilt rotation axis 12, as illustrated in FIG. 4A, before the tilt axis rotation is unlocked in step 303, θi is to be within the range of 0 to 90 degrees. In a case where Oi is located within the range of 0 to 90 degrees, the system control unit 50 determines that balance adjustment can be continued, and the flow proceeds to step S307. On the other hand, in a case where fi is located outside the range of 0 to 90 degrees, the system control unit 50 determines that balance adjustment fails, and the flow proceeds to step S306.

In step S306, the system control unit 50 notifies the user of balance adjustment failure, and this flow ends.

In step S307, the system control unit 50 unlocks the fourth slide plate 20 using the slide plate lock unit 75, and starts moving the fourth slide plate 20 in the fourth slide axis +direction 28 using the fourth slide plate drive unit 19. Next, in step S308, the system control unit 50 determines whether the tilt angle θ (tilt axis rotation angle) is 0 degrees (θ−0). In a case where the tilt angle θ becomes 0 degrees as illustrated in FIG. 4C, the system control unit 50 determines that balance adjustment of the fourth slide plate 20 is completed, and the flow proceeds to step S310. The system control unit 50 continues moving the fourth slide plate 20 until the tilt angle θ becomes 0 degrees, and in step S309, and determines whether the fourth slide plate 20 has reached the operation end in the fourth slide axis +direction 28. In a case where the fourth slide plate 20 has reached the operation end in the fourth slide axis +direction 28, the system control unit 50 proceeds to step S306.

In step S310, the system control unit 50 stops moving the fourth slide plate 20 using the fourth slide plate drive unit 19, and fixes the fourth slide plate 20 using the slide plate lock unit 75. Next, in step S311, the system control unit 50 stores a moving amount ΔS4a of the fourth slide plate 20 from the operation end of the fourth slide axis −direction 29 until the tilt angle θ becomes 0 degrees, which is acquired by the slide plate control unit 70.

Next, in step S312, the system control unit 50 calculates a target moving amount ΔS3t of the third slide plate 18 to align the tilt-movable-unit center-of-gravity 401 with the tilt rotation axis 12. FIG. 5 illustrates a relationship among the tilt angle θi, the moving amount ΔS4a of the fourth slide plate 20, and the target moving amount ΔS3t of the third slide plate 18. Since the tilt angle θi and the moving amount ΔS4a of the fourth slide plate 20 have already been acquired in the flow up to this point, the target moving amount ΔS3t of the third slide plate 18 can be calculated using the equation: ΔS3t=ΔS4a/tanθi.

Next, in step S313, the system control unit 50 determines whether the calculated target moving amount ΔS3t of the third slide plate 18 is within the movable range of the third slide plate 18. In a case where the target moving amount ΔS3t is within the movable range of the third slide plate 18, the flow proceeds to step S314. On the other hand, in a case where the target moving amount ΔS3t is outside the movable range, the flow proceeds to step S306.

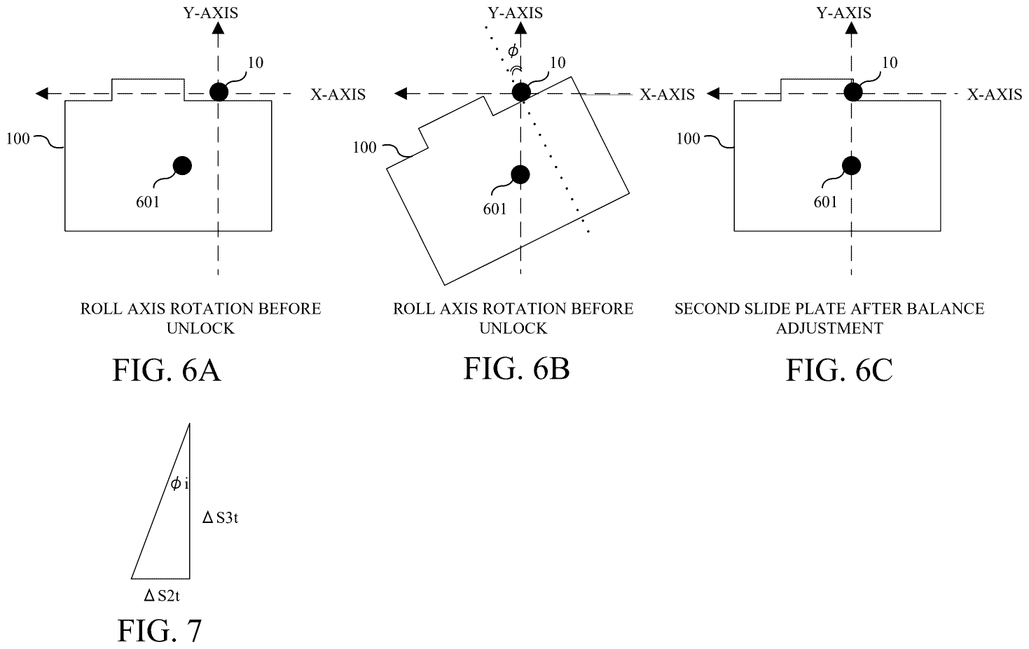

FIGS. 6A, 6B, and 6C illustrate the image pickup apparatus 100 viewed from the roll drive unit 9 side, and explain the balance adjustment of the second slide plate 16. In step S302, the slide plate is moved to the initial position. Thus, as illustrated in FIG. 6A, the roll-movable-unit center-of-gravity 601, which is the combination of the image pickup apparatus 100, the lens apparatus 200, and the second slide plate drive unit 15 to the camera fixed pedestal 21, is assumed to be in the fourth quadrant on the XY plane centered on the roll rotation axis 10. At this time, in a case where the roll axis rotation is unlocked by the rotation axis lock unit 64 in step S314, the roll-movable-unit center-of-gravity 601 is tilted so as to move onto the Y-axis (FIG. 6B).

Next, in step S315, the system control unit 50 defines the tilt angle of the roll axis rotation of the image pickup apparatus 100 relative to the normal position as φ, and stores the tilt angle φi (rotation angle before roll axis adjustment) obtained by the rotation control unit 60 just after the roll axis rotation is unlocked. In this embodiment, the tilt angle φ (first tilt angle) of the image pickup apparatus 100 is a tilt angle relative to the normal position as a reference position (predetermined position) of the image pickup apparatus 100, but is not limited to this example, and a position other than the normal position may be set to the reference position.

Next, in step S316, the system control unit 50 determines whether φi is within the range of 0 to 90 degrees (0°≤φi≤90°). In a case where the roll movable unit gravity center 601 is located in the fourth quadrant on the XY plane centered on the roll rotation axis 10 as illustrated in FIG. 6A before the roll axis rotation is unlocked in step 314, φi is to be within the range of 0 to 90 degrees. In a case where qi is within the range of 0 to 90 degrees, the system control unit 50 determines that balance adjustment can be continued and the flow proceeds to step S317. On the other hand, in a case where θi is outside the range, the system control unit 50 determines that balance adjustment fails and the flow proceeds to step S306.

In step S317, the system control unit 50 calculates a target moving amount ΔS2t of the second slide plate 16 to align the roll-movable-unit center-of-gravity 601 with the roll rotation axis 10. FIG. 7 illustrates a relationship between the tilt angle qi, the target moving amount ΔS4t of the second slide plate 16, and the target moving amount ΔS3t of the third slide plate 18. In the flow up to this point, the tilt angle qi and the target moving amount ΔS3t of the third slide plate 18 have already been calculated in step S312, so the target moving amount ΔS2t of the second slide plate 16 can be calculated using the equation ΔS2t=ΔS3t×tanθi.

Next, in step S318, the system control unit 50 determines whether the calculated target moving amount ΔS2t of the second slide plate 16 is within the movable range of the second slide plate 16. In a case where the target moving amount ΔS2t is within the movable range of the second slide plate 16, the flow proceeds to step S319. On the other hand, if the target moving amount ΔS2t is outside the movable range, the flow proceeds to step S306.

In step S319, the system control unit 50 unlocks the second slide plate 16 using the slide plate lock unit 75, and starts moving the second slide plate 16 in the second slide axis −direction 25 using the second slide plate drive unit 15. Next, in step S320, the system control unit 50 determines whether the tilt angle φ is 0 degrees (φ−0). In a case where the tilt angle φ is 0 degrees as illustrated in FIG. 6C, the system control unit 50 determines that the balance adjustment of the second slide plate 16 is completed, and the flow proceeds to step S322. Alternatively, in a case where the moving amount ΔS2 of the second slide plate 16 by the second slide plate drive unit 15 matches the target moving amount ΔS2t of the second slide plate 16, the system control unit 50 determines that the balance adjustment of the second slide plate 16 is completed, and the flow proceeds to step S322.

The second slide plate 16 continues to move until the inclination angle q becomes 0 degrees or the moving amount ΔS2 of the second slide plate 16 matches ΔS2t. In step S321, the system control unit 50 determines whether the second slide plate 16 has reached the operation end of the second slide axis −direction 25. In a case where it is determined that the second slide axis has reached the operation end of the second slide axis −direction 25, the flow proceeds to step S306.

In step S322, the system control unit 50 stops moving the second slide plate 16 using the second slide plate drive unit 15 and fixes the second slide plate 16 using the slide plate lock unit 75.

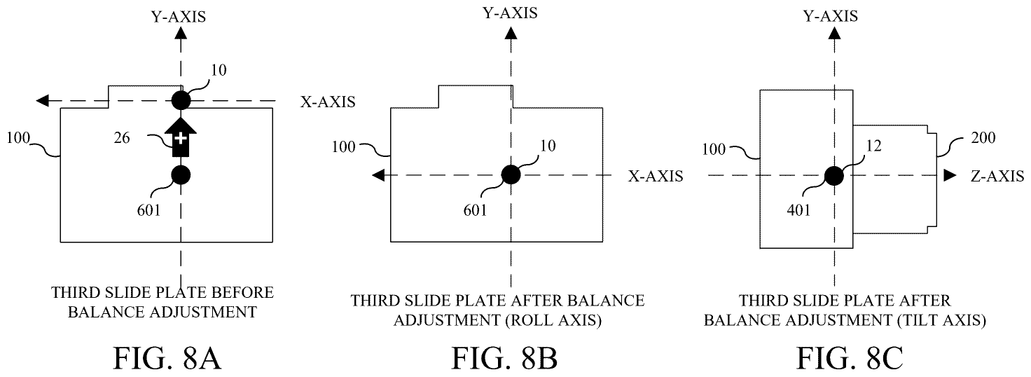

FIGS. 8A and 8B illustrate the image pickup apparatus 100 from the roll drive unit 9 side, and FIG. 8C illustrates the image pickup apparatus 100 and the lens apparatus 200 from the tilt drive unit 11 side. The balance adjustment of the third slide plate 18 will be discussed using these figures. In a case where step S322 is completed, the state of FIG. 8A is obtained.

Next, in step S323, the system control unit 50 unlocks the third slide plate 18 using the slide plate lock unit 75, and starts moving the third slide plate 18 in the third slide axis +direction 26 using the third slide plate drive unit 17. At this time, the control torque T for moving the third slide plate 18 is set to 0. For example, in a case where the third slide drive motor included in the third slide plate drive unit 17 is a linear actuator using a DC motor, the control duty of the DC motor starts from 0%.

Next, in step S324, the system control unit 50 increases the power P3 or torque T for moving the third slide plate 18 in a stepped manner using the third slide plate drive unit 17. This is continued until the moving amount ΔS3 of the third slide plate 18 is no longer 0, that is, until the third slide plate 18 starts moving. That is, in a case where the moving amount ΔS3 is 0 in step S325, the system control unit 50 returns to step S324. On the other hand, in a case where the moving amount ΔS3 is 0, that is, in a case where the third slide plate 18 starts moving, the flow proceeds to step S326.

In step S326, the system control unit 50 stores information on the power P3 or torque Ts when the third slide plate 18 starts moving. Next, in step S327, the system control unit 50 determines whether the moving amount ΔS3 of the third slide plate 18 matches the target moving amount ΔS3t of the third slide plate 18. In a case where these moving amounts match, the roll-movable-unit center-of-gravity 601 and the tilt movable unit gravity center 401 are located on the roll rotation axis 10 and the tilt rotation axis 12, respectively, as illustrated in FIGS. 8B and 8C, so it is determined that the balance adjustment of the third slide plate 18 has been completed, and the flow proceeds to step S328. On the other hand, in a case where the moving amount ΔS3 of the third slide plate 18 and the target moving amount ΔS3t of the third slide plate 18 do not match, the system control unit 50 continues to move the third slide plate 18.

In step S328, the system control unit 50 stops moving the third slide plate 18 using the third slide plate drive unit 17, and fixes the third slide plate 18 using the slide plate lock unit 75.

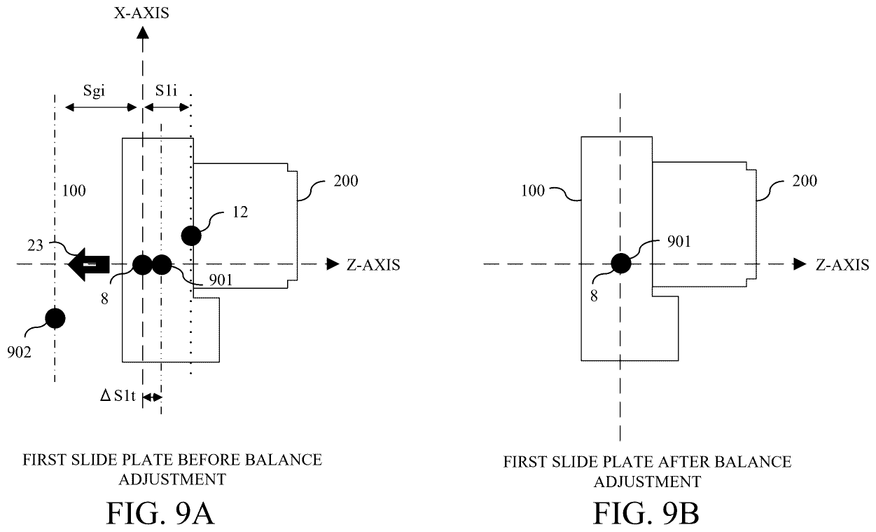

FIGS. 9A and 9B illustrate the image pickup apparatus 100 and the lens apparatus 200 viewed from the +direction of the Y-axis, and explain the balance adjustment of the first slide plate 14. FIG. 9A illustrates a positional relationship of the center of gravity of the first slide plate 14 before the balance adjustment. In step S329, the system control unit 50 calculates a target moving amount ΔS1t of the first slide plate 14. The target moving amount ΔS1t of the first slide plate 14 is a distance between the pan-movable-unit center-of-gravity 901, which is the combination of the image pickup apparatus 100, the lens apparatus 200, and the first slide plate drive unit 13 to the camera fixed pedestal 21, and the pan rotation axis 8 in the moving direction of the first slide plate 14. That is, the target moving amount ΔS1t can be calculated, for example, by the following equation:

$$Δ S 1 t = ( M \times S 1 i + Mg \times Sgi ) / ( M + Mg )$$

Here, M is the combined weight of the image pickup apparatus 100, the lens apparatus 200, and the weight from the third slide plate drive unit 17, which is part of the gimbal apparatus 1, to the camera fixed pedestal 21 (not illustrated), hereafter referred to as a tilt axis weight. S1i is a distance between the tilt rotation axis 12 (tilt-movable-unit center-of-gravity 401) and the pan rotation axis 8 in the moving direction of the first slide plate 14. Mg is a combined weight from the first slide plate drive unit 13 to the tilt drive unit 11, which are parts of the gimbal apparatus 1. Sgi is a distance between a gimbal-arm center-of-gravity 902 from the first slide plate drive unit 13 to the tilt drive unit 11, which are parts of the gimbal apparatus 1, and the pan rotation axis 8 in the moving direction of the first slide plate 14.

ΔS1t, S1i, and Sgi have a positive sign on the first slide axis +direction 22 side from the pan rotation axis 8, and a negative sign on the opposite side. S1i, Mg, and Sgi are values that are determined by the gimbal apparatus 1, regardless of the image pickup apparatus 100 and lens apparatus 200 as the mounted object, and are therefore previously stored in the nonvolatile memory 51. The nonvolatile memory 51 also stores the correspondence between start-up power P3s or torque Ts of the third slide plate 18 and the tilt axis weight M, for example, in a table format. The system control unit 50 determines (estimates) the tilt axis weight M using the information on the start-up power P3s or torque Ts of the third slide plate 18 acquired in step S326.

Next, in step S330, the system control unit 50 determines whether the calculated target moving amount ΔS1t of the first slide plate 14 is equal to or less than 0 (ΔS1t≤0). In step S302, the first slide plate 14 is moved to the operation end in the first slide axis +direction 22. Therefore, in a case where the target moving amount ΔS1t of the first slide plate 14 is greater than 0, the system control unit 50 determines that it is outside the balance adjustment range and the flow proceeds to step S306. On the other hand, in a case where the target moving amount ΔS1t of the first slide plate 14 is equal to or less than 0, the flow proceeds to step S331.

In step S331, the system control unit 50 determines whether the calculated target moving amount ΔS1t of the first slide plate 14 is located within the movable range of the first slide plate 14 (movable amount of the first slide plate 14≥ΔS1t). In a case where the target moving amount ΔS1t is located within the movable range of the first slide plate 14, the flow proceeds to step S332. On the other hand, in a case where the target moving amount ΔS1t is located outside the movable range, the flow proceeds to step S306.

In step S332, the system control unit 50 unlocks the first slide plate 14 using the slide plate lock unit 75, and starts moving the first slide plate 14 in the first slide axis −direction 23 using the first slide plate drive unit 13. Next, in step S333, the system control unit 50 determines whether the moving amount ΔS1 of the first slide plate 14 matches the target moving amount ΔS1t of the first slide plate 14 (ΔS1=ΔS1t). In a case where the moving amount ΔS1 matches the target moving amount ΔS1t, as illustrated in FIG. 9B, the pan-movable-unit center-of-gravity 901 is located on the pan rotation axis 8. Therefore, the system control unit 50 determines that the balance adjustment of the first slide plate 14 is completed, and the flow proceeds to step S334. On the other hand, in a case where the moving amount ΔS3 of the first slide plate 14 and the target moving amount ΔS3t of the first slide plate 14 do not match, the system control unit 50 continues moving the first slide plate 14.

In step S334, the system control unit 50 stops moving the first slide plate 14 using the first slide plate drive unit 13, and fixes the first slide plate 14 using the slide plate lock unit 75. Next, in step S335, the system control unit 50 notifies the user that balance adjustment of all slide axes has been completed, and this flow ends.

As described above, the gimbal apparatus 1 according to this embodiment has a structure to which the mounted object is detachably attachable, and includes a slide unit, a rotator, a slide position detector, a rotation position detector, a control unit (and a memory), a fixed unit, and a tilt detector. The slide unit includes at least one slide unit (e.g., the first to fourth slide plates 14, 16, 18, and 20) translatable in a predetermined direction. The rotator includes at least one rotator (e.g., the pan drive unit 7, the roll drive unit 9, and the tilt drive unit 11) rotatable around a predetermined axis. The slide position detector is at least one detector (e.g., first to fourth encoders 71, 72, 73, and 74) configured to detect position information on each slider. The rotation position detector is at least one detector (e.g., pan axis encoder 61, roll axis encoder 62, tilt axis encoder 63) configured to detect rotation angle information on each rotator. The memory stores instructions. The control unit (system control unit 50, rotation control unit 60, slide plate control unit 70) that, upon execution of the instructions, is configured to control the slider based on the position information, and control the rotator based on the rotation angle information. The fixed unit (camera fixed pedestal 21) fixes the mounted object. The tilt detector (attitude detector 80) detects the tilt angle of the mounted object fixed to the fixed unit relative to a predetermined position. The control unit is configured to determine the moving amount of the slider so as to reduce the tilt angle.

The control unit may determine the moving amount of the slider using the tilt angle so that the movable-unit center-of-gravity (401, 601, 901) of the rotator approaches the predetermined axis (or so that the movable-unit center-of-gravity coincides with the predetermined axis).

The gimbal apparatus 1 may further include a rotation axis lock unit 64 configured to fix the rotator, and the tilt detector detects the tilt angle while the rotator is unlocked by the rotation axis lock unit.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can provide a gimbal apparatus that can perform balance adjustment even in a case where information on a mounted object cannot be obtained.

This application claims priority to Japanese Patent Application No. 2024-111447, which was filed on Jul. 11, 2024, and which is hereby incorporated by reference herein in its entirety.

What is claimed is:

1. A gimbal apparatus to which a mounted object is detachably attachable, the gimbal apparatus comprising:
a slider translatable in a predetermined direction;
a rotator rotatable around a predetermined axis;
a slide position detector configured to detect position information on the slider;
a rotation position detector configured to detect rotation angle information on the rotator;
a memory storing instructions;
a processor that, upon execution of the instructions, is configured to control the slider based on the position information and control the rotator based on the rotation angle information;
a fixed unit configured to fix the mounted object; and
a tilt detector configured to detect a tilt angle of the mounted object fixed to the fixed unit relative to a predetermined position,
wherein the processor is configured to determine a moving amount of the slider so as to reduce the tilt angle.

2. The gimbal apparatus according to claim 1, wherein the processor is configured to determine the moving amount of the slider using the tilt angle so that a center of gravity of a movable unit of the rotator approaches the predetermined axis.

3. The gimbal apparatus according to claim 1, further comprising a rotation axis lock unit configured to locks the rotator,
wherein the tilt detector detects the tilt angle while the rotator is unlocked by the rotation axis lock unit.

4. The gimbal apparatus according to claim 1, wherein the tilt detector includes an acceleration sensor, and
wherein the acceleration sensor is disposed between the fixed unit and the rotator.

5. The gimbal apparatus according to claim 1, further comprising a holder for a user to hold the gimbal apparatus,
wherein the tilt detector includes an acceleration sensor,
wherein the acceleration sensor is provided to the holder, and
wherein the processor is configured to calculate the tilt angle of the mounted object relative to a gravity direction using an output of the acceleration sensor and an output of the rotation position detector.

6. The gimbal apparatus according to claim 1, wherein the processor is configured to determine a weight of the mounted object using information on power or torque for moving the slider.

7. The gimbal apparatus according to claim 1, wherein the slider includes:
a first slider translatable in a first direction,
a second slider translatable in a second direction,
a third slider translatable in a third direction, and
a fourth slider translatable in a fourth direction,
wherein the rotator includes:
a first rotator rotatable around a first rotation axis,
a second rotator rotatable around a second rotation axis, and
a third rotator rotatable a third rotation axis.

8. The gimbal apparatus according to claim 7, wherein the tilt detector detects a first tilt angle of the mounted object relative to the predetermined position while a rotation of the second rotator is unlocked,
wherein the processor is configured to determine a moving amount of the second slider or the third slider so as to reduce the first tilt angle,
wherein the tilt detector detects a second tilt angle of the mounted object while a rotation of the third rotator is unlocked, and
wherein the processor is configured to determine a moving amount of the third slider or the fourth slider so as to reduce the second tilt angle.

9. The gimbal apparatus according to claim 7, wherein the first slider is movable by a rotation of the first rotator,
wherein the second slider is movable by a rotation of the second rotator,
wherein the third slider and the fourth slider are movable by the third rotator, and
wherein the processor is configured to:
move the first slider and the second slider so as to change a position of a center of gravity of the mounted object relative to the first rotator,
move the second slider and the third slider so as to change the position of the center of gravity relative to the second rotator,
move the third slider and the fourth slider so as to change the position of the center of gravity relative to the third rotator.

10. A method for controlling a gimbal apparatus, to which a mounted object is detachably attachable, and the gimbal apparatus including a slider translatable in a predetermined direction, a rotator rotatable around a predetermined axis, and a fixed unit configured to fix the mounted object, the method comprising:
detecting a tilt angle of the mounted object fixed to the fixed unit relative to a predetermined position; and
determining a moving amount of the slider so as to reduce the tilt angle.

11. A non-transitory computer-readable storage medium storing a program that causes a computer to execute the method according to claim 10.
